(19) United States
(12) Patent Application Publication
(10) Pub. No.: US 2013/0162057 A1
(43) Pub. Date: Jun. 27, 2013

(54) HOLLOW RING TORUS MAGNET GENERATOR

(71) Applicant: Randal Scott Turner, Granite Falls, WA (US)

(72) Inventor: Randal Scott Turner, Granite Falls, WA (US)

(21) Appl. No.: 12/891,788

(22) Filed: Sep. 27, 2010

Related U.S. Application Data
(63) Continuation-in-part of application No. 12/102,912, filed on Apr. 15, 2008, now abandoned.

(51) Int. Cl. H02K 1/06

(52) U.S. Cl. CPC H02K 1/06
USPC 310/10

(57) ABSTRACT

A hollow ring torus permanent magnet generator, with a sphere shaped permanent magnet which spins/revolves within the hollow ring torus passing through insulated copper magnet wire windings wound around the exterior portion of the ring torus shaped body wherein the passing of the sphere shaped permanent magnet through the coil produces electrical current in the insulated copper magnet wire windings.

### CROSS-REFERENCE TO RELATED APPLICATION

This Application is a Continuation-in-Part of U.S. patent application Ser. No. 12/102,912, filed by the Applicant on 15 Apr. 2008.

### BACKGROUND OF THE INVENTION

### Field of Invention

The present invention relates generally to low-voltage permanent magnet electrical generators and, more specifically, to a hollow ring torus permanent magnet electrical generator.

It is well known that a high power permanent magnet can be used in conjunction with insulated copper wire to produce electricity, by passing insulated copper wire through the magnetic field of a permanent magnet. By having the copper wire continuously leaving and reentering the magnetic field, this motion forces electrons along the copper wire, thus producing electricity that can be used to power low voltage electrical devices such as light emitting diodes or other electrical components that require low voltage.

However one of the problems associated with present state-of-the-art low voltage permanent magnet generators is that most conventional electrical generators incorporate and rely on the use of a center rotating axle with either: (i) a first configuration having insulated copper coil windings affixed to the axle such that the copper coil windings rotate between two permanent magnets; or (ii) a second configuration having magnets affixed to the axle such that the magnets rotate past insulated copper coil windings, such as disclosed in U.S. Pat. No. 5,650,681 “Electric current generation apparatus” issued to DeLerno. Both types of configurations thus comprise magnets and copper coil windings which move relative to one another. Accordingly, each configuration requires that the generator comprise at least two independent moving parts, and further requires a bearing set or similar apparatus for supporting the rotating generator axle.

The prior art also provides for a linear motion electric power generator, such as disclosed in U.S. Pat. No. 5,347,186 “Linear motion electric power generator” issued to Konotchick. A shortcoming of a linear motion electric power generator is that activation of the generator requires movement in a linear motion, such as by shaking side to side or up and down, so as to repeatedly force the magnet through the coils. The configuration of a linear motion electric power generator thus limits use of the generator to applications in which such linear motion can be provided and maintained. For example, a linear motion electric power generator will not operate in an application in which external spinning or rotating forces act on the generator, as the result would be to cause the magnet to remain at one end of the linear motion electric power generator while the generator is being rotated or spun.

What is needed is an electric power generator configuration which addresses the problems in the current state of the art of: (i) requiring a center axle/shaft that moves independently, or (ii) that requires a user to impart a shaking motion to activate the electrical generator.

### SUMMARY OF THE INVENTION

The present invention results from the realization that, by restraining a ball/sphere shaped neodymium magnet to movement inside of a hollow ring torus shaped tube; with the neodymium magnet constantly circling through insulated copper coils when the ring torus shaped tube is spun, or rolled in a side-to-side motion, relatively low-voltage electricity can be produced. The insulated copper wire that is wound around the hollow ring torus is formed into coils at one or more positions on the hollow ring torus shaped tube. With this motion, the neodymium magnet functions to force electrons through the copper coils/wires as the magnetic field from the moving neodymium magnet continually passes through the copper coils so as to produce electricity to power, for example, light emitting diodes or other devices that require low voltage electrical power.

In an exemplary embodiment of the present invention, a hollow ring torus permanent magnet electrical generator assembly comprises: a first portion consisting: a hollow ring torus shaped housing of non-magnetic durable material (e.g., plastic, aluminum, hardened rubber), a hollow cavity within, that encapsulates a round/sphere shaped neodymium permanent magnet, which rolls around the inner hollow torus tube, continuously circling through insulated copper wire windings, which wind around the outer portion of the hollow torus tube.

These and other features and advantages of the present invention will be more fully understood from the following detailed description with reference to the accompanying drawings.

### BRIEF DESCRIPTION OF DRAWINGS

FIG. 1 is a perspective view of a hollow ring torus permanent magnet electrical generator assembly in accordance with an aspect of the present invention;

FIG. 2 is a perspective exploded view of the hollow ring torus permanent magnet electrical generator assembly of FIG. 1, showing an exemplary method of assembly;

FIG. 3 is a top-sectioned view of the hollow ring torus permanent magnet electrical generator assembly of FIG. 1, showing an internal configuration;

FIG. 4 is a flow chart illustrating operation of the hollow ring torus permanent magnet electrical generator assembly of FIG. 1;

FIG. 5 is a side view of the hollow ring torus permanent magnet electrical generator assembly of FIG. 1;

FIG. 6 is a side sectioned perspective view of the hollow ring torus permanent magnet electrical generator assembly of FIG. 1 showing a cross sectional view of an inner chamber;

FIG. 7 is a top-sectioned perspective view of an aspect of the hollow ring torus permanent magnet electrical generator assembly of FIG. 1 showing a top view of the sectioned hollow torus shaped inner chamber; and,

FIG. 8 is a cross-sectional view of a flashlight powered by the hollow ring torus permanent magnet electrical generator assembly of FIG. 1.

### DETAILED DESCRIPTION

The present invention provides a hollow ring torus permanent magnet electrical generator that operates on motion imparted by an external random or periodic mechanical force. The external force may produce a spinning, rolling, rotating, or undulant mechanical motion to the electrical generator, and thus causes a captive magnetic sphere to roll within the hollow ring torus and generate electricity by repeatedly passing through one or more electrical coils disposed on the outer surface of the hollow ring torus.

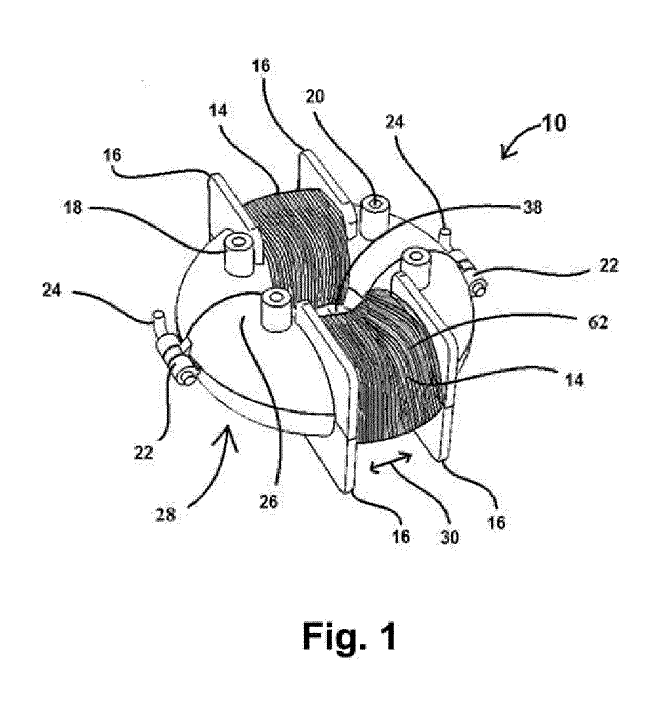

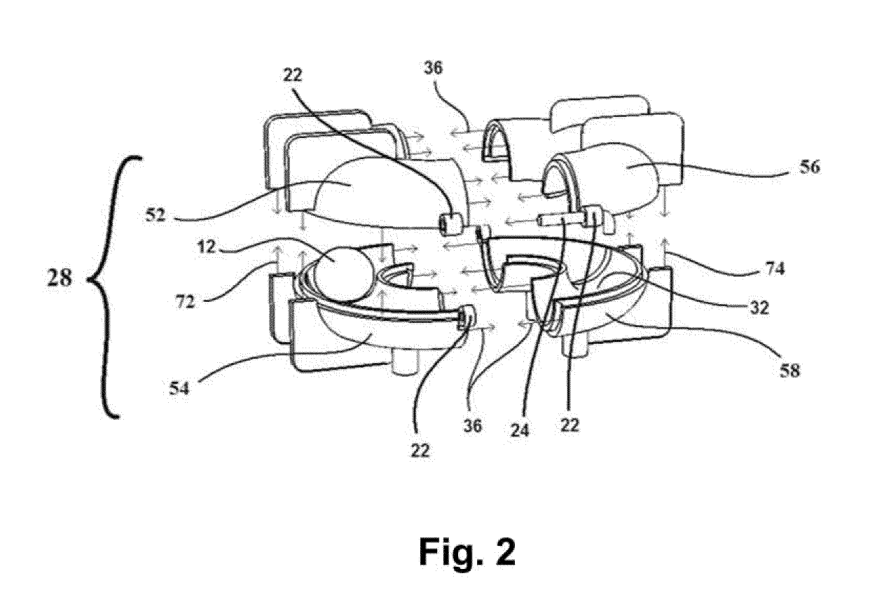

FIG. 1 shows a hollow ring torus permanent magnet electrical generator assembly 10 in accordance with the present invention. As best shown in FIG. 2, the hollow ring torus permanent magnet electrical generator assembly 10 comprises four principal quadrant assemblies for ease of assembly, here denoted as a first quadrant assembly 52, a second quadrant assembly 54, a third quadrant assembly 56, and a fourth quadrant assembly 58. The first quadrant assembly 52, the second quadrant assembly 54, the third quadrant assembly 56, and the fourth quadrant assembly 58 are assembled to form a hollow torus/doughnut shape housing 28 with a center hole 38, as shown in FIG. 1.

In the exemplary embodiment shown, the hollow ring torus permanent magnet electrical generator assembly 10 also includes two insulated copper coil windings 14, each coil winding 14 retained within a respective channel 30 defined on a contoured outer shell 26. Each coil winding 14 may be formed by winding insulated copper wire 62 within channels 30, to occupy the space between two walls 16, and around the outer shell 26 of the hollow torus/doughnut shape housing 28. That is, the insulated copper wire 62 is generally wound in layers, the successive layers disposed on top of one another to form a bundle or coil comprising a plurality of layers or windings, as is well-known in the art.

The two coil windings 14 may be formed from a continuous length of insulated copper wire, or each coil winding 14 may comprise a separate length of insulated copper wire. It should be understood that the hollow ring torus permanent magnet electrical generator assembly 10 can alternatively comprise one, three, or more insulated copper coil windings 14 (not shown), as desired by the generator designer. As best seen in FIGS. 1, 2, and 5, each wall 16 is configured to extend partially around the contoured outer shell 26, the extent of the wall 16 being long enough to retain the copper wires in place to form the coil on the outer shell 26.

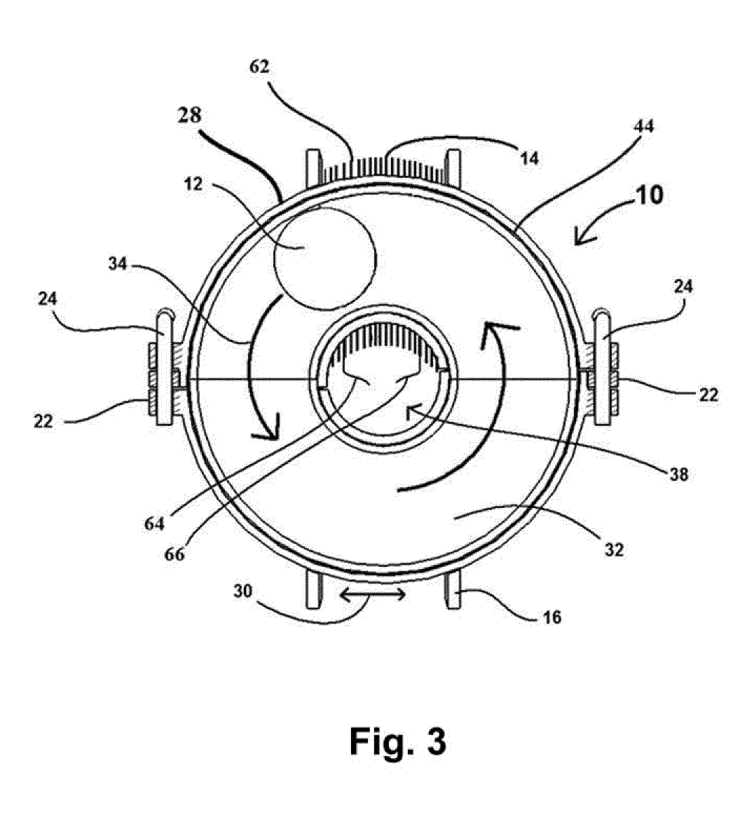

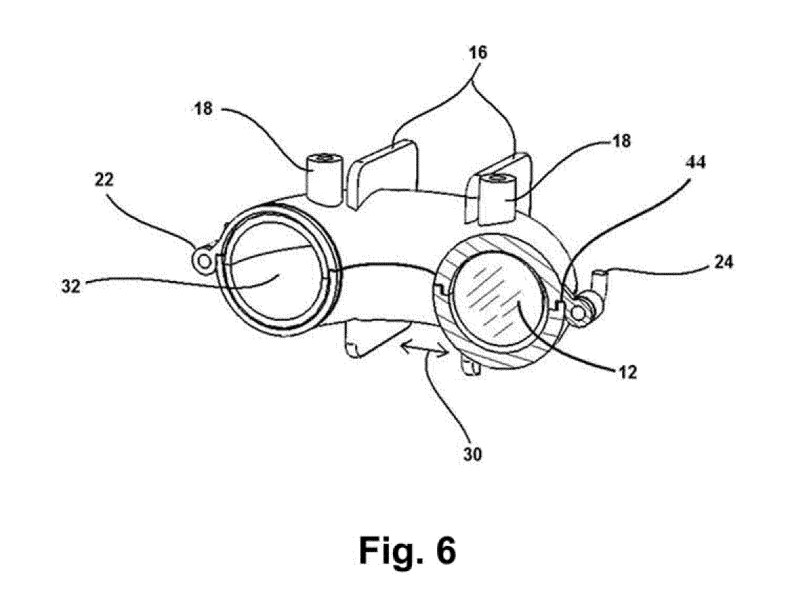

The insulated copper wire 62 in each coil winding 14 has a first wire end 64 and a second wire end 66, as shown in the exemplary embodiment of FIG. 3. The first wire end 64 and the second wire end 66 thus form respective electrical leads that remain exposed after the coil winding 14 has been formed, to provide for electrically attaching to: a low voltage electrical device such as a light-emitting diode, a capacitance, or to another electrical load (not shown). Such electrical devices can be mechanically mounted to mounting posts 18, for example, shown in FIGS. 1 and 6. The electrical device can be fastened by screws (not shown) which mate with holes 20, and are tightened to secure the respective electrical device.

As can be seen more clearly in FIG. 2, the hollow ring torus permanent magnet electrical generator assembly 10 may be fabricated by: (i) attaching the first quadrant assembly 52 and the second quadrant assembly 54 to one another in the direction indicated by arrows 72; (ii) attaching the third quadrant assembly 56 and the fourth quadrant assembly 58 to one another in the directions illustrated by arrows 74; and (iii) attaching the first quadrant assembly 52 to the third quadrant assembly 56 and the second quadrant assembly 54 to the fourth quadrant assembly 58 as indicated by arrows 36. In an exemplary embodiment, attachment may be provided by an epoxy, solder, brazing, thermal bonding, or other adhesive means so as to provide a hermetic seal at contact surfaces and enable use of the hollow ring torus permanent magnet electrical generator assembly 10 in water or similar adverse environments.

As can best be seen in FIG. 6, a circumferential ridge 44 may be provided at the interface between the first quadrant assembly 52 and the second quadrant assembly 54 to facilitate assembly of the first quadrant assembly 52 to the second quadrant assembly 54. The insulated copper wire 62 may then be wound around the channel 30, formed when the first quadrant assembly 52 is mounted to the second quadrant assembly 54, to fill the space between the side walls 16, and then taped into place with the two wire ends 64 and 66 left accessible, as shown in FIG. 3, for connecting to a low voltage electrical device as described above. As best seen in FIGS. 3 and 6, the circumferential ridge 44 extends along the outer circumference of the hollow ring torus permanent magnet electrical generator 10 so as to also facilitate mounting of the third quadrant assembly 56 to the fourth quadrant assembly 58, as indicated by the arrows 74 in FIG. 2. After the third quadrant assembly 56 has been assembled to the fourth quadrant assembly 58, the insulated copper wire 62 may then be wound around the channel 30 to form the coil winding 14 enclosing the third quadrant assembly 56 and the fourth quadrant assembly 58.

In an exemplary embodiment, a first subassembly may be formed, comprising the coil winding 14 enclosing the first quadrant assembly 52, as described above. Likewise, a second subassembly may be formed, comprising the coil winding 14 enclosing the third quadrant assembly 56 mounted to the fourth quadrant assembly 58. The sphere shaped neodymium permanent magnet 12, may be placed into an inner torus chamber 32 in either the first subassembly or the second subassembly. The first subassembly may then be attached to the second subassembly to complete assembly of the hollow torus/doughnut shape housing 28. As best shown in FIGS. 3, 5, and 7, final assembly may be performed by using a locking pin 24 in each of two through holes 40. However, it will be understood that other forms of connections may be used such as, screws, or clamps for example.

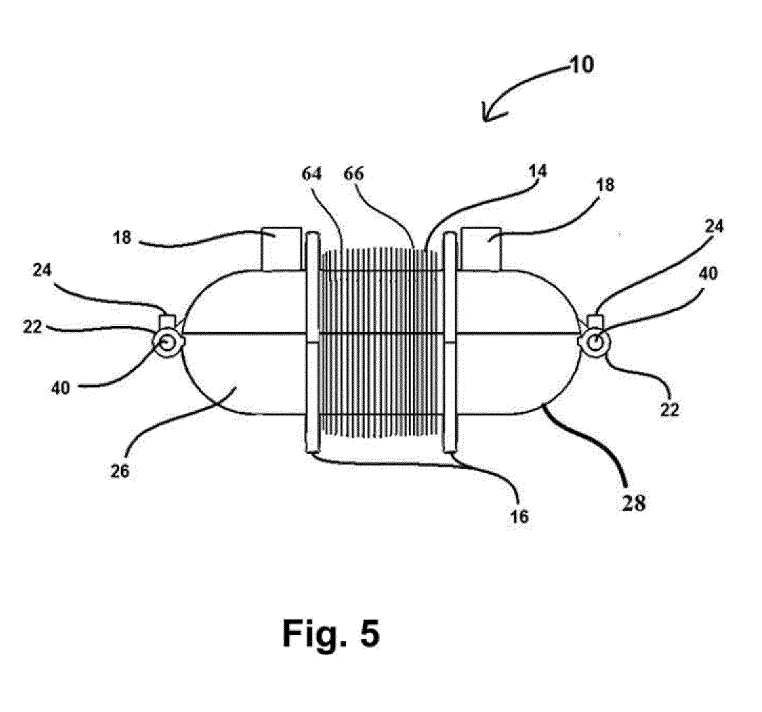

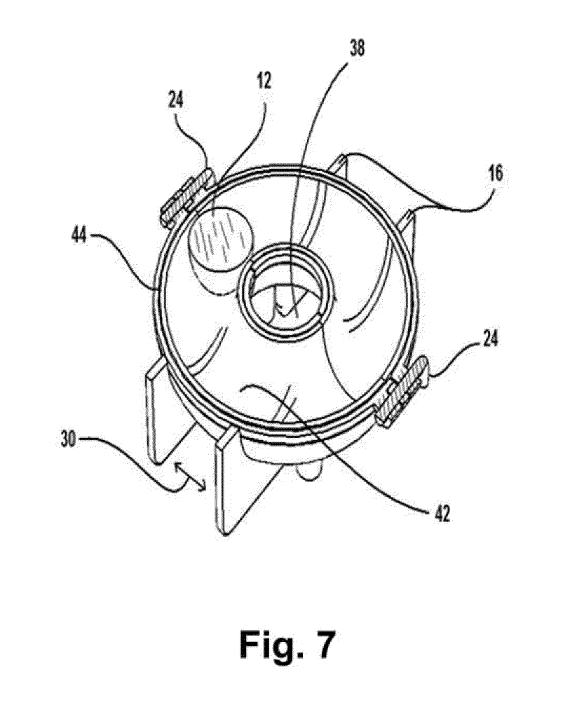

As shown in FIG. 5, the mounting posts 18 may be configured to allow for adding a mounting plate (not shown), such as diode plate 50 shown in FIG. 7 of related U.S. Pat. No. 5,818,132. The mounting plate may accommodate light emitting diodes or other electrical devices, and may be secured to the mounting posts 18 by fasteners (not shown) suitably mated with holes 20, as seen in FIG. 1.

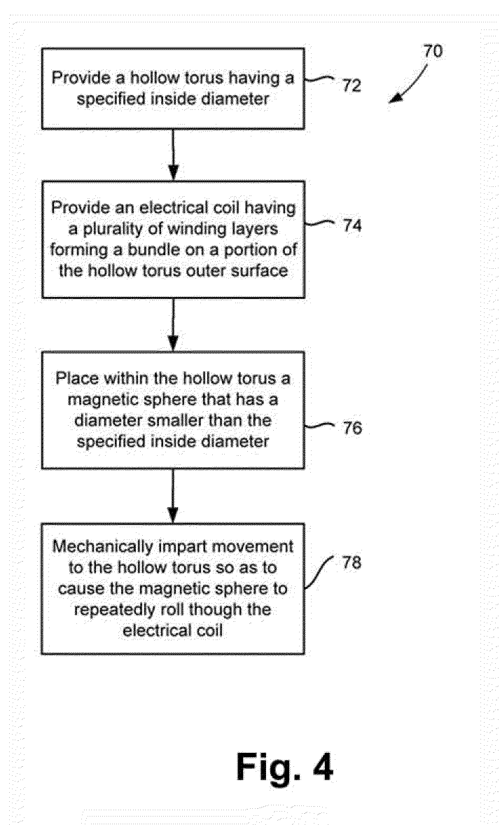

As shown in FIG. 3, and with further reference to a flow diagram 70 in FIG. 4, a method of generating low-voltage electricity comprises providing a hollow torus having a specified inside diameter, as in step 72. In the example provided, the hollow torus is formed from the first quadrant assembly 52, the second quadrant assembly 54, the third quadrant assembly 56, and the fourth quadrant assembly 58, as described above. At least one electrical coil is provided on the hollow torus, at step 74. This may comprise a plurality of winding layers on a section of the hollow torus, such as the coil winding 14 disposed on a portion of the hollow torus/doughnut shape housing 28, shown in FIG. 1.

A magnetic sphere, such as the sphere shaped neodymium permanent magnet 12, is placed inside the hollow torus, where the magnetic sphere has a diameter smaller than the inside diameter of the hollow torus, at step 76. Accordingly, the sphere shaped neodymium permanent magnet 12 is free to roll inside of the inner torus chamber 32, in a circular path or direction 34. The user imparts an appropriate movement to the hollow ring torus permanent magnet electrical generator 10 so as to cause the magnetic sphere to repeatedly interact with the one or more electrical coils, such as by rolling through or moving with respect to the one or more electrical coils, at step 78. In the exemplary embodiment shown in FIG. 3, this rolling action causes the magnetic field of the sphere shaped neodymium permanent magnet 12 to pass through the two coil windings 14, which action in turn forces electrons through the insulated copper wire 62 creating electrical current to power a low voltage electrical device (not shown) such as may be mounted to the mounting posts 18, as described above.

It can be appreciated by one skilled in the art that the contoured outer shell 26 encloses the inner torus chamber 32 so as to form a ring torus 42, as can be seen in greater detail in FIG. 7. As the sphere shaped neodymium permanent magnet 12 is slightly smaller in diameter than the surface of the inner torus chamber 32, this configuration allows the sphere shaped neodymium permanent magnet 12 to roll continuously and freely inside of the inner torus chamber 32. Accordingly, the magnetic field from the sphere shaped neodymium permanent magnet 12 repeatedly passes through the coil windings 14, when the hollow ring torus permanent magnet electrical generator assembly 10, is spinning or rolling in a side to side motion to generate electricity.

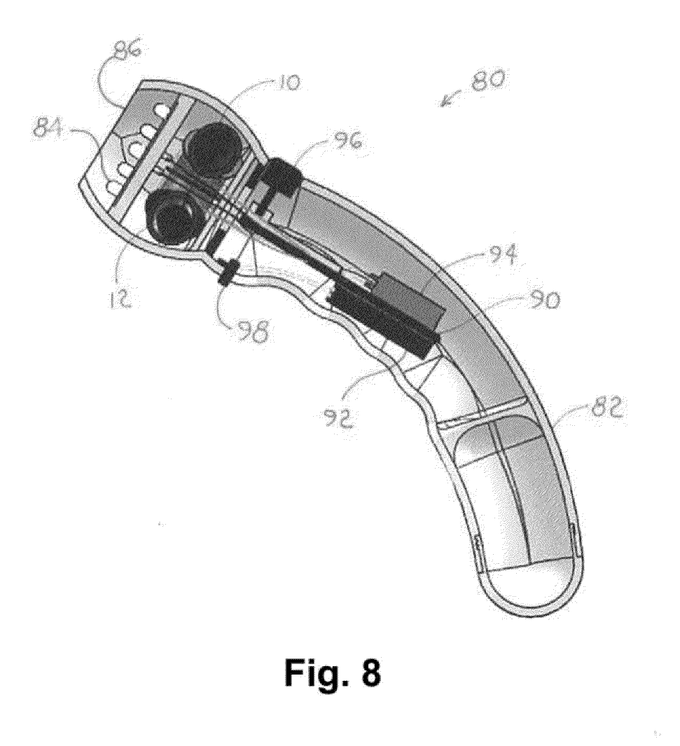

FIG. 8 shows a flashlight 80 utilizing the hollow ring torus permanent magnet electrical generator assembly 10 as a power source. The flashlight 80 comprises a housing 82, and a plurality of light-emitting diodes 84 disposed behind a lens 86. A circuit board 90 may be housed within the flashlight 80, where the circuit board 90 is in electrical communication with a relay 92 and a capacitor 94, such as an aerogel capacitor. The user imparts motion to the flashlight 80 to cause the sphere shaped neodymium permanent magnet 12 to roll within the hollow ring torus permanent magnet electrical generator assembly 10, as described above, and accumulate charge on the capacitor 94.

The charge accumulated on the capacitor 94 can be used to power the light emitting diodes 86, using an on/off switch 96, for continuous operation as a conventional flashlight. Alternatively, by using a strobe selection switch 98, the user can select a strobe operation wherein the charge stored in the capacitor 94 is controlled by relay 92 to provide a pulsed output at the light emitting diodes 86, such as an “S.O.S.” signal, rather than a continuous “flashlight” operation. When the charge stored in the capacitor 94 is low or depleted, the user can recharge the capacitor 94 by again imparting motion to the flashlight 80.

It is to be understood that the description herein is exemplary of the invention only and is intended to provide an overview for the understanding of the nature and character of the invention as it is defined by the claims. The accompanying drawings are included to provide a further understanding of various features and embodiments of the method and apparatus of the invention which, together with their description serve to explain the principles and operation of the invention. Thus, while the invention has been described with reference to particular embodiments, it will be understood that the present invention is by no means limited to the particular constructions and methods herein disclosed and/or shown in the drawings, but also comprises any modifications, alterations, additions, or equivalents within the scope of the claims.

What is claimed is:

1. A hollow ring torus permanent magnet generator assembly comprising:
a hollow ring torus shaped housing, the housing defining a center hole to form the ring shape;
a coil winding formed from a plurality of winding layers of insulated copper magnet wire, the coil winding enclosing a portion of the hollow ring shaped torus housing and passing through the center hole; and
a spherical neodymium permanent magnet moveably retained within the interior of the hollow ring torus shaped housing such that electricity is generated in the insulated copper magnet wire by passing the spherical neodymium permanent magnet through the coil.

2. The generator assembly of claim 1, wherein insulated copper wire comprising two ends of the coil winding form respective leads so as to provide for attachment to an external electrical device.

3. The generator assembly of claim 2, further comprising four mounting posts with holes for providing attachment surfaces for the external electrical device.

4. The generator assembly of claim 1, wherein the hollow ring torus shaped housing comprises a non-magnetic material.

5. The generator assembly of claim 4, wherein the non-magnetic material comprises a material selected from the group consisting of plastic, aluminum, and hardened rubber.

6. The generator assembly of claim 1, wherein the interior of the hollow ring torus shaped housing is larger in diameter than the spherical neodymium permanent magnet, such that an externally applied mechanical force induces the spherical neodymium permanent magnet to move and roll within the hollow ring torus shaped housing, to thus enable the magnetic field of the spherical neodymium permanent magnet to repeatedly electrically interact with the coil and to generate an electrical current in the coil.

7. The generator assembly of claim 1, further comprising:
a second coil winding formed from a plurality of winding layers of the insulated copper magnet wire, the second coil winding enclosing a second portion of the hollow ring torus shaped housing and passing through the center hole.

8. The generator assembly of claim 1, wherein the hollow ring torus shaped housing comprises a first quadrant assembly, a second quadrant assembly, a third quadrant assembly, and a fourth quadrant assembly.

9. The generator assembly of claim 8, further comprising means for hermetically sealing the generator housing.

10. The generator assembly of claim 9, wherein the means for sealing comprises a member of the group consisting of: an epoxy, solder, a brazing operation, and a thermal bonding operation.

11. The generator of claim 1, further comprising a pair of walls formed on the hollow ring torus shaped housing to define a channel, each wall disposed at a corresponding side of the coil winding such that the coil winding is retained within the channel, each wall further configured to extend partially around the surface of the hollow ring torus shaped housing.
